(19) United States
(12) Patent Application Publication
(10) Pub. No.: US 2016/0019349 A1
(43) Pub. Date: Jan. 21, 2016

(54) ONE CLICK LAB SERVICE SIGN UP

(71) Applicant: PRACTICE FUSION, INC., San Francisco, CA (US)

(72) Inventors: Jeremy Paul ROSS, Sacramento, CA (US); Paula Billington, San Francisco, CA (US)

(73) Assignee: PRACTICE FUSION, INC., San Francisco, CA (US)

(21) Appl. No.: 14/333,357

(22) Filed: Jul. 16, 2014

(51) Int. Cl. G06F 19/00

(52) U.S. Cl. CPC G06F 19/322; G06F 19/327

(57) ABSTRACT

In an embodiment, a computer-implemented method integrates a healthcare provider with a medical lab. In the method, the EHR system validates the medical lab to ensure that the medical lab is able to communicate with the EHR system in a format the EHR system understands. After the EHR system validates the medical lab, the EHR system receives, from the healthcare provider, a lab sign up request for connecting the healthcare provider to the medical lab. In response to receipt of the lab sign up request from the healthcare provider, the EHR system binds the healthcare provider and the medical lab via the EHR system. Then, the healthcare provider can order a lab test for a patient of the healthcare provider to the medical lab.

### BACKGROUND

1. Field

This field is generally related to integration of healthcare providers and medical labs.

2. Background

### Electronic Health Records

Medical records related to a patient's health information are essential to the practice of medical care. Traditionally, medical records were paper-based documents. The emergence of electronic medical records (EMR), which are digital version of the paper chart that contains all of a patient's medical history from one medical practice, offers medical professionals and patients with new functionalities and efficiencies that paper-based medical records cannot provide. An electronic health record (EHR), also known as an electronic medical record (EMR), is a collection of electronically stored information about an individual patient's medical history. EHRs may contain a broad range of data, including demographics, medical history, medication history, allergies, immunization records, laboratory test results, radiology images, vital signs, personal statistics like age and weight and billing information. Many commercial EHR systems combine data from a number of healthcare services and providers, such as clinical care facilities, laboratories, radiology centers and pharmacies.

EHRs are a drastic improvement over paper-based medical records. Paper-based medical records require a large amount of physical storage space. Paper records are often stored in different locations and different medical professionals may each have different and incomplete records about the same patient. Obtaining paper records from multiple locations for review by a healthcare provider can be time consuming, complicated and sometimes impossible. In contrast, EHR data is stored in digital format and thus are more secure and can be accessed from anywhere. EHR systems significantly simplify the reviewing process for healthcare providers. Because records in EHRs can be linked together, EHRs vastly improve the accessibility of health records and the coordination of medical care.

EHRs also decrease the risk of misreading errors by healthcare professionals. Poor legibility is often associated with handwritten, paper medical records, which can lead to medical errors. EHRs, on the other hand, are inherently legible given that they are typically stored in typeface. In addition, electronic medical records enhance the standardization of forms, terminology and abbreviations and data input, which help ensure reliability of medical records and standardization of codesets and storage of EHR data means that data from different technical information systems can be displayed in a single, unified record. Further, EHRs can be transferred electronically, thus reducing delays and errors in recording prescriptions or communicating laboratory test results.

The benefits of digitizing health records are substantial. Healthcare providers with EHR systems have reported better outcomes, fewer complications, lower costs and fewer malpractice claim payments. But despite EHRs' potential in drastically improving the quality of medical care, only a low percentage of healthcare providers use EHR systems. While the advantages of EHRs are significant, they also carry concerns, including high costs, lost productivity during EHR implementation or computer downtime and lack of EHR usability.

The Health Insurance Portability and Accountability Act (HIPAA), enacted in the U.S. in 1996 and as amended, established rules for use and access of protected health information (PHI). HIPAA provides restrictions on disclosure of and access to protected health information to and by third parties. HIPAA applies to information in electronic medical records, such as health information doctors and nurses input, documented conversations between a doctor and a patient and information use to process or facilitate medical billing claims and documents. The HIPAA Security Rule, effective on Apr. 20, 2005 for most covered entities, adds additional constraints to electronic data security and the storage and transmission of PHI.

The high cost of EHRs also significantly hinders EHR adoption. A large number of physicians without EHRs have referred to initial capital costs as a barrier to adopting EHR systems. Cost concerns are even more severe in smaller healthcare settings, because current EHR systems are more likely to provide cost savings for large integrated institutions than for small physician offices. During the EHR technology's setup and implementation process, productivity loss can further offset efficiency gains. The need to increase the size of information technology staff to maintain the system adds even more costs to EHR usages.

Usability is another major factor that holds back adoption of EHRs. It is particularly challenging to develop user-friendly EHR systems. There is a wide range of data that needs to be integrated and connected. Complex information and analysis needs vary from setting to setting, among healthcare provider groups and from function to function within a healthcare provider group. To some providers, using electronic medical records can be tedious and time consuming and the complexity of some EHR systems renders the EHR usage less helpful. Some doctors and nurses also complain about the difficulty and the length of time to enter patients' health information into the system.

Under-utilization of EHR systems, despite incentives and mandates from the government and the tremendous potential of EHRs in revolutionizing the healthcare system, calls for better EHR systems that are secure, cost-effective, efficient and user-friendly.

Comprehensive EHR systems can provide capabilities far beyond simply storing patients' medical records. Because EHR systems offer healthcare providers and their workforce members the ability to securely store and utilize structured health information, EHR systems can have a profound impact on the quality of the healthcare system. In Framework for Strategic Action on Health Information Technology, published on Jul. 21, 2004, the Department of Health & Human Services (HHS) outlined many purposes for EHR services. The outlined purposes include, among other things, improving healthcare outcomes and reducing costs, reducing recordkeeping and duplication burdens, improving resource utilization, care coordination, active quality and health status monitoring, reducing treatment variability and promoting patients' engagement in and ownership over their own healthcare.

Recent legislation has set goals and committed significant resources for health information technology (IT). One of the many initiatives of the American Recovery and Reinvestment Act of 2009 (ARRA) was “to increase economic efficiency by spurring technological advances in science and health.” The Health Information Technology for Economic and Clinical Health (HITECH) Act, passed as a part of ARRA, allocated billions of dollars for healthcare providers to adopt and meaningfully use EHRs in their practices. HITECH also mandates the Office of the National Coordinator for Health Information Technology (ONC) to define certification criteria for “Certified EHR Technology.”

EHR systems satisfying “Certified EHR Technology” criteria are capable of performing a wide range of functions, including: entry and storage, transmission and receipt of care summaries, clinical decision support, patient lists and education resources, generation of public health submission data and patient engagement tools. Entry and storage is related to the ability to enter, access and modify patient demographic information, vital signs, smoking status, medications, clinical and radiology laboratory orders and results. Transmission and receipt of care summaries involve the ability to receive, incorporate, display and transmit transition of care/referral summaries. Clinical decision support features configurable clinical decision support tools, including evidence-based support interventions, linked referential clinical decision support and drug-drug and drug-allergy interaction checks. Patient lists and education resources include the ability to create patient lists based on problems, medications, medication allergies, demographics and laboratory test result values and the ability to identify patient-specific education resources based on such data elements. Generating public health submission data allows users to create electronic immunization and syndromic surveillance data files that can be submitted to public health agencies. Patient engagement tools allow medical professionals to grant patients with an online means to view, download and transmit their health information to a third party, provide patients with clinical summaries after office visits and facilitate secure-doctor patient messaging.

Some EHR systems allow healthcare providers to integrate with clinical laboratories to create computerized provider order entry (“CPOE”) clinical laboratory orders and electronically receive and incorporate clinical laboratory tests and results into a patient's chart. This integration can also support functionality that enables medical healthcare providers to electronically receive and incorporate radiology laboratory test results (e.g., x-ray, ultrasound, MRI, PET/CT scan, mammography) into a patient's chart. However, the process of integrating a healthcare provider with a medical lab can be cumbersome.

### BRIEF SUMMARY

In an embodiment, a computer-implemented method integrates a healthcare provider with a medical lab. In the method, the EHR system validates the medical lab to ensure that the medical lab is able to communicate with the EHR system in a format the EHR system understands. After the EHR system validates the medical lab, the EHR system receives, from the healthcare provider, a lab sign up request for connecting the healthcare provider to the medical lab. In response to receipt of the lab sign up request from the healthcare provider, the EHR system binds the healthcare provider and the medical lab via the EHR system. Then, the healthcare provider can order a lab test for a patient of the healthcare provider to the medical lab.

System and computer program product embodiments are also disclosed.

Further embodiments, features and advantages of the invention, as well as the structure and operation of the various embodiments, are described in detail below with reference to accompanying drawings.

### BRIEF DESCRIPTION OF THE DRAWINGS

The accompanying drawings, which are incorporated herein and form part of the specification, illustrate the present disclosure and, together with the description, further serve to explain the principles of the disclosure and to enable a person skilled in the relevant art to make and use the disclosure.

FIG. 1 is a flowchart illustrating a method for integrating a healthcare provider with a medical lab.

FIG. 2 is a flowchart illustrating a method for validating the medical lab in the EHR system.

FIG. 3 is a flowchart illustrating a method for enabling the healthcare provider to sign up lab service in one click after the EHR system validates the medical lab.

FIG. 4 is a flowchart illustrating a method for the EHR system to process a lab test order.

FIG. 5 is a diagram illustrating an example system for integration of a healthcare provider with a medical lab.

FIG. 6 is a diagram illustrating an example computing device.

FIG. 7 is an illustration of an example medical record.

The drawing in which an element first appears is typically indicated by the leftmost digit or digits in the corresponding reference number. In the drawings, like reference numbers may indicate identical or functionally similar elements.

### DETAILED DESCRIPTION

Integration of a healthcare provider with a medical lab is often difficult and time consuming. Usually the integration process requires many steps before the healthcare provider can place lab test orders for its patients. Each individual healthcare provider needs to negotiate with the medical lab separately to verify that the medical lab provides legitimate services. The healthcare provider also needs to provide detailed information about the medical lab to the EHR system. The integration process can take several weeks for the healthcare provider as it is cumbersome for the healthcare provider to gather and verify all information required by the EHR system. The integration process can also be error-prone as the detailed information about the medical lab may include many fields (e.g., name, address, communication method of the medical lab). A mistake from entering incorrect information could prevent the EHR system from recognizing the correct medical lab. As result, the healthcare provider may have to to restart the integration process while its patients are waiting for perhaps time-critical lab tests.

To address these issues, embodiments allow a healthcare provider to sign up for services of a medical lab via the EHR system. Before a healthcare provider begins to subscribe for services provided by a medical lab, the EHR system validates the medical lab. During validation, the EHR system gathers lab information that enables the healthcare provider to complete the sign up process efficiently. After validation, the healthcare provider can place orders for lab tests to the medical lab via the EHR system.

In the detailed description that follows, references to “one embodiment”, “an embodiment”, “an example embodiment”, etc., indicate that the embodiment described may include a particular feature, structure or characteristic, but every embodiment may not necessarily include the particular feature, structure or characteristic. Moreover, such phrases are not necessarily referring to the same embodiment. Further, when a particular feature, structure or characteristic is described in connection with an embodiment, it is submitted that it is within the knowledge of one skilled in the art to effect such feature, structure or characteristic in connection with other embodiments whether or not explicitly described.

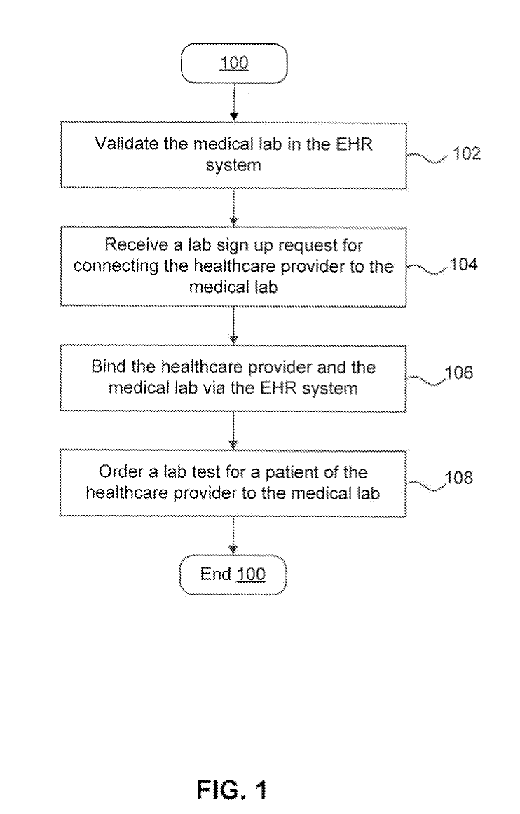

FIG. 1 is a flowchart illustrating a method 100 for integrating a healthcare provider with a medical lab, according to embodiments.

Method 100 begins at step 102 by validating a medical lab in the EHR system. A medical lab may be a clinical laboratory that performs tests on clinical specimens to get health information of a patient related to the diagnosis, treatment and prevention of disease. Examples of laboratory tests performed by a clinical laboratory include detection of the abnormal cells that cause leukemia, analysis of cardiac enzyme activity released during a heart attack, identification of a type of bacteria causing an infection or detection of DNA markers for genetic diseases. A medical lab may, for example, be a radiology laboratory that provides radiology and diagnostic imaging. The imaging can include x-ray, ultrasonography, radioisotope (nuclear) scanning, computed tomography (CT), magnetic resonance imaging (MRI), positron emission tomography (PET) and angiography. The validation of step 102 ensures that the medical lab is able to communicate with the EHR system in a format that the EHR system understands. Validating the medical lab also ensures that the medical lab is authorized to provide lab services to healthcare providers. A healthcare provider is an individual practitioner or a medical facility that provides preventive, curative or rehabilitative healthcare services to individuals, families or communities.

After the EHR system validates the medical lab, the EHR system may provide an option for the healthcare provider to initiate the sign up process for the services provided by the medical lab. In one embodiment, the healthcare provider initiates the sign up process by sending a lab sign up request to the EHR system for connecting the healthcare provider to the medical lab. In one example, the lab sign up request is transmitted as a hypertext transfer protocol (HTTP) request. In some embodiments, the lab sign up request includes information necessary for the EHR system to identify the medical lab that the healthcare provider requests to connect to. At step 104, the EHR system receives the lab sign up request from the healthcare provider.

In response to receipt of the lab sign up request, the EHR system binds the healthcare provider and the medical lab at step 106. Binding sets up an association between the healthcare provider and the medical lab in the EHR system. The association allows the healthcare provider to send lab test orders to the medical lab. The association also enables medical lab to send back lab test results to the healthcare provider and its patients. In some embodiments, the EHR system binds the healthcare provider and the medical lab by establishing an application layer connection between the healthcare provider and the medical lab via the EHR system. The medical lab can receive the lab test orders over the application layer connection. The medical lab can send back lab test results over the application layer connection as well. In one embodiment, the application layer connection uses the Health Level-7 (HL7) protocol.

Once the EHR system binds the healthcare provider and the medical lab, the EHR system may place lab test orders on behalf of the healthcare provider at step 108. In some embodiments, the healthcare provider may send a lab test order for a patient to the EHR system and the EHR system may forward the lab test order to the medical lab.

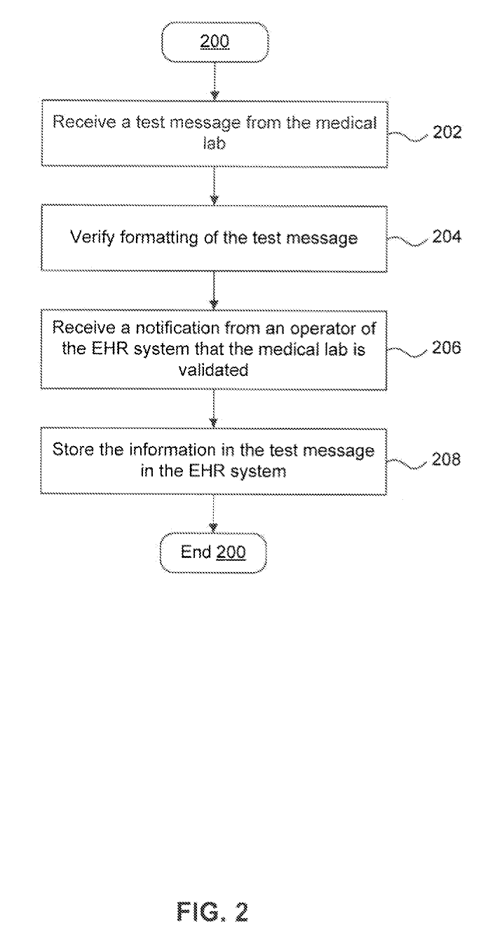

FIG. 2 is a flowchart illustrating a method 200 for validating the medical lab in the EHR system. Method 200 illustrates an example implementation of step 102 in FIG. 1.

At step 202, the EHR system receives a test message from the medical lab. In one embodiment, the EHR system may provide an application programming interface (API) that enables a medical lab to open a connection to the EHR system. The medical lab may send the test message via the connection using the API provided by the EHR system. In one embodiment, the connection uses the HL7 protocol. The test message may include information about the medical lab (e.g., name, address, types of services provided). At step 204, the EHR system performs automatic verification of the test message sent by the medical lab. The automatic verification may include verifying that the test message is in a format that the EHR system can understand. In addition, the EHR system may check missing fields in the testing message.

Once the EHR system finishes verifying the formatting of the test message, the EHR system may present information in the test message to an operator of the EHR system for further validation. After the operator finishes the further validation, the EHR system receives a notification that the medical lab is authorized to work with the EHR system at step 206.

At the end of the validation process, the EHR system stores information about the medical lab at step 208. The stored information may come from the test message which includes name, address and types of services provided by the medical lab. In one embodiment, the test message may include connection information (e.g. IP address and port number) to the medical lab. Later, the EHR system may use the connection information to connect to the medical lab. The stored information may include additional information created during the validation process. In another embodiment, the EHR system may maintain the active connection that the medical lab uses to send the test message. The connection information may include the active connection. The EHR system can store the active connection and later place lab test orders via the same active connection to the medical lab.

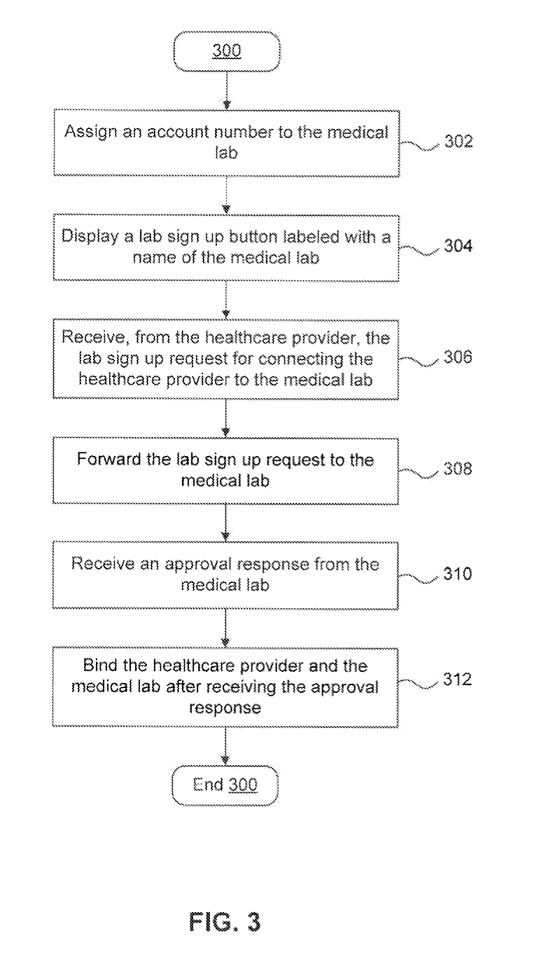

In some embodiments, the EHR system completes the validation of the medical lab before allowing any healthcare provider to sign up for the services the medical lab provides. The benefit of this approach is that prior validation by the EHR system saves time and effort of individual healthcare providers from verifying that the medical lab is legitimate. In addition, since the EHR system already stores information associated with the medical lab at the validation stage, each individual healthcare provider does not need to fill in detailed information about the medical lab to sign up for the medical lab's services. FIG. 3 is a flowchart illustrating an example method 300 for enabling the healthcare provider to sign up for medical lab services in one click after the EHR system validates the medical lab.

After the EHR system completes the validation process for a medical lab, method 300 starts at step 302. At step 302, the EHR system assigns an account number to the medical lab. The account number uniquely identifies the medical lab and the EHR system can use the account number to retrieve information associated with the medical lab (e.g., name, address, type of services or connection information). At step 304, the EHR system presents a graphical user interface (GUI) to the healthcare provider for lab service sign up. In one embodiment, the sign up GUI is a web page provided by a web server of the EHR system. In another embodiment, the sign up GUI is a part of a standalone client application, running on the healthcare provider's computing device, connected to the EHR system. In the sign up GUI, the EHR system provides an option for the healthcare provider to sign up for the medical lab's services. In one example, the EHR system displays a lab sign up button in the GUI. The label of the lab sign up button may be the medical lab's name or logo. The GUI may embed the account number of the medical lab and associate the lab sign up button with the account number.

If the healthcare provider decides to sign up for the medical lab's services, the healthcare provider can complete the sign up process with a single click of the lab sign up button. Once the healthcare provider clicks the lab sign up button, no more work is required on the healthcare provider side. The sign up GUI generates a lab sign up request and sends the lab sign up request to the EHR system upon the click of the lab sign up button. Because the lab sign up button is associated with the account number of the medical lab, the lab sign up request sent to the EHR system may include the account number to help the EHR system to identify the medical lab. The lab sign up request may also include an identifier that identifies the healthcare provider.

At step 306, the EHR system receives the lab sign up request for connecting the healthcare provider to the medical lab. In one embodiment, the EHR system can extract the account number of the medical lab from the lab sign up request. Based on the account number, the EHR system may retrieve information associated with the medical lab. In one example, the EHR system may retrieve the connection information using the account number as a search key. Then, the EHR system forwards the lab sign up request to the medical lab using the connection information at step 306. If the connection information is an IP address (or hostname) and a port number, the EHR system creates a connection using the IP address (or hostname) and the port number, then forwards the lab sign up request to the medical lab via the created connection. If the connection information is an active connection to the medical lab maintained by the EHR system, the EHR system reuses the active connection to forward the lab sign up request. In one embodiment, the EHR system forwards the same lab sign up request to the medical lab. In another embodiment, the EHR system modifies the lab sign up request in a format that the medical lab understands and forwards the modified lab sign up request to the medical lab.

After the medical lab receives the lab sign up request, the medical lab needs to approve the sign up request. For example, the medical lab may check whether a service agreement was entered between the healthcare provider and the medical lab. Once the medical lab approves the lab sign up request, the EHR system receives an approval response from the medical lab at step 310. In response to receipt of the medical lab's approval response, the EHR system binds the healthcare provider and the medical lab at step 312. The binding sets up an association between the healthcare provider and the medical lab. As described above, the association allows the healthcare provider to send lab test orders to the medical lab via the EHR system. The association also enables medical lab to send back lab test results via the EHR system.

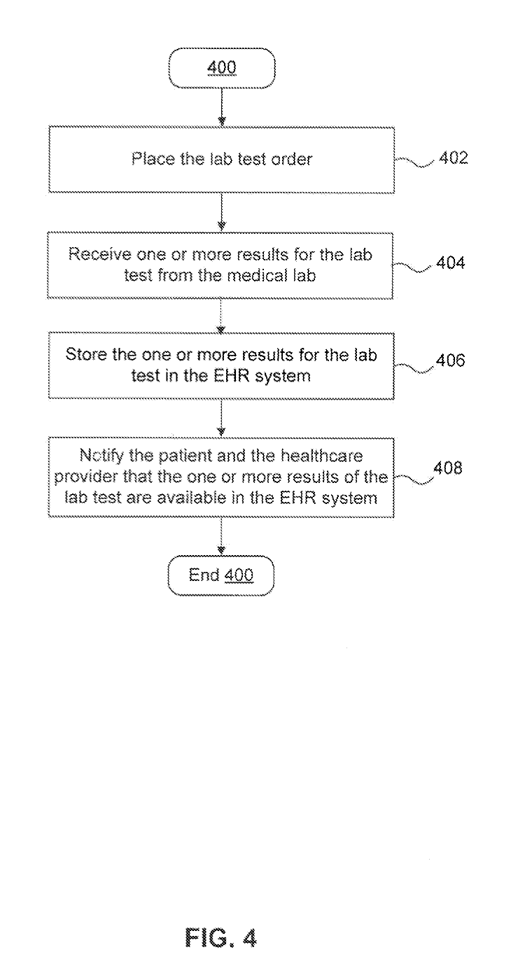

FIG. 4 is a flowchart illustrating a method 400 for the EHR system to handle a lab test order. After the sign up and the binding between the healthcare provider and the medical lab in the EHR system, the healthcare provider may submit a lab test order for a patient of the healthcare provider to the EHR system. The lab test order may include the account number of the medical lab. The lab test order may also include the patient's identifier and the healthcare provider's identifier.

After the EHR system receives the lab test order for a patient from the healthcare provider, the EHR system places the lab test order by sending the lab test order to the medical lab at step 402. Similar to what is described above, if the EHR system maintains the active connection to the medical lab, the EHR system may send the lab test order to the medical lab by reusing the active connection. Otherwise, EHR system may open a new connection to the medical lab using the connection information (e.g., IP address or hostname) obtained during the stage of validating the medical lab.

After the medical lab receives the lab test order and generates one or more lab test results, the medical lab sends the one or more lab test results back to the EHR system. At step 404, the EHR system receives the one or more test results from the medical lab. In some occasions, the lab test may generate multiple test results during a period of time. For example, the lab test may be related to periodically monitoring a patient's heart rates. Sometimes, the medical lab may send the multiple lab test results at the rate higher than what the EHR system can handle. In this case, the EHR system may start a throttling mechanism by notifying the medical lab to slow down and send the lab test results at a lower rate that the EHR system can handle. The EHR system then only accepts the lab test results at the lower rate.

At step 406, the EHR system stores the received lab test results. In some embodiments, the EHR system stores the lab test results in the database. The patient or the healthcare provider can then view the test results by logging into the EHR system. In some cases, the lab test results can be time sensitive as the lab test results may be critical to the diagnosis and treatment of the patient's disease. Thus, the EHR system may send notifications to the patient and/or the healthcare provider as soon as the EHR system receives the lab test results. Because the EHR system maintains information about the patient and the healthcare provider in the EHR's database, the EHR system can send notifications by using the information stored in the EHR's database. Examples of the notifications may be, not limited to, text messages or emails. In some embodiments, the notification sent to the patient or the healthcare provider may be a simple text indicating that the lab test results are ready for retrieval. In other embodiments, the notification may provide a link and the patient or the healthcare provider can directly access the lab test results by clicking on the link provided in the notification.

### System

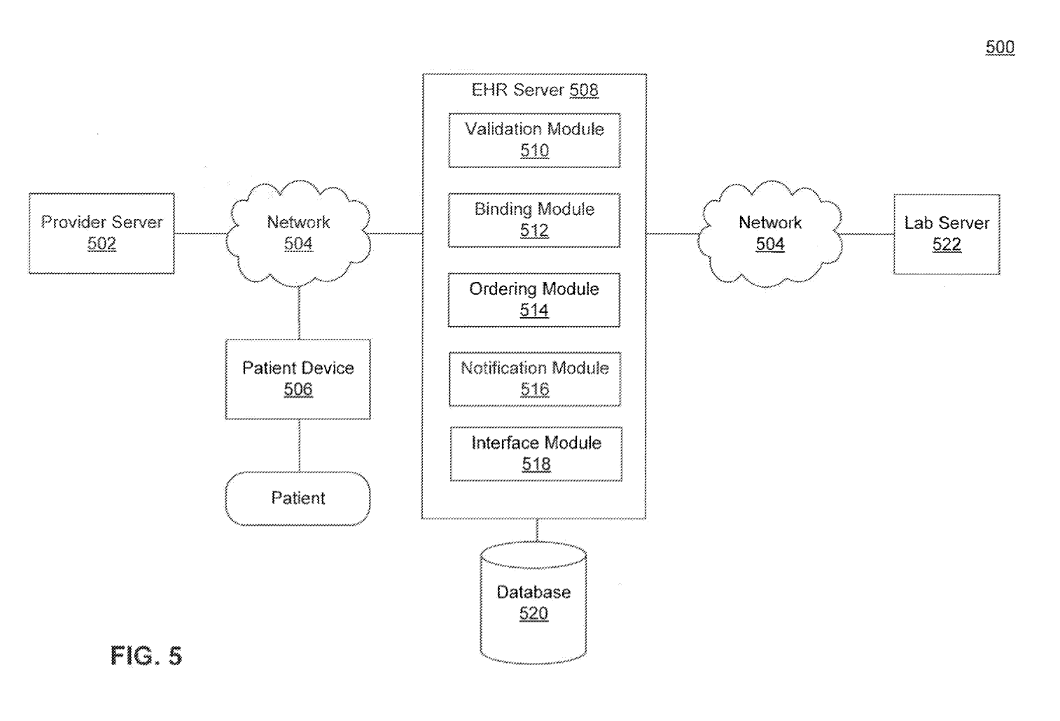

FIG. 5 is a diagram illustrating an example system 500 for connecting a healthcare provider to a medical lab. System 500 includes healthcare provider server 502, EHR server 508 and medical lab server 522, all connected by one or more networks 504, such as the Internet. System 500 may also include patient device 506 connected to EHR server 508 by network 504. EHR server 508 is coupled to one or more databases. For example, EHR server 508 may be coupled to database 520. EHR server 508 may be part of a comprehensive EHR system, as described in further detail below. The medical lab may communicate with EHR server 508 using medical lab server 522. The healthcare provider may communicate with EHR server 508 using healthcare provider server 502. A patient of the healthcare provider may use patient device 506 to communicate with EHR server 508. Example EHR server 508, medical lab server 522, patient device 506 or healthcare provider server 502 include, but not limited to, any type of processing device including a computer, workstation, distributed computing system, embedded system, stand-alone electronic device, networked device, mobile device (such as a smartphone, tablet computer or laptop computer), set-top box, television or other type of processor or computer system.

To connect the healthcare provider to the medical lab, EHR server 508 may operate as described above for FIGS. 1-4. In the embodiment of FIG. 5, EHR server 508 includes five modules: validation module 510, binding module 512 ordering module 514, notification module 516 and interface module 518. Each module is described below in turn.

Validation module 510 validates the medical lab in the EHR system to ensure that the medical lab is able to communicate with the EHR system in a format that the EHR system understands. Validation module 510 may receive one or more test messages from the medical lab and performs automatic verification for the test messages. For example, validation module 510 may check formatting of the medical lab's test message to ensure that ERR server 508 understands it. The validation module may present the one or more test messages to an operator of the EHR system for further validation. After the operator of the EHR system completes the further validation, validation module 510 receives a notification from an operator of the EHR system indicating that the medical lab is authorized to work with the EHR system.

Validation module 510 may store information about the medical lab. For example, validation module 510 may extract information contained the one or more test messages and store the extracted information in database 520. The one or more test messages include, but not limited to, name, address and types of services provided by the medical lab. The test messages may further contain connection information (e.g. IP address and port number) to the medical lab. The stored information may include additional information created during the validation process. For example, validation module 510 may provide an open application programming interface (API) for a medical lab to connect to the EHR system. Once connected, validation module 510 may maintain the active connection that the medical lab uses to send the test messages. Validation module 510 can store the active connection and later the EHR system can place lab test orders by reusing the same active connection to the medical lab. Validation module 510 may also assign a unique identifier (e.g., account number) to the validated medical lab. The EHR system can retrieve information associated with the medical lab using the account number of the medical lab as a search key.

In some embodiments, validation module 510 ensures that validation of the medical lab completes before other modules on ER server 508 start the lab sign up process or lab test ordering process to the medical lab. The validation by validation module 510 saves time and effort for individual healthcare providers from verifying that the medical lab provides legitimate services. Also, since validation module 510 already stores information associated with the medical lab at the validation stage, individual healthcare providers do not need to fill in detailed information about the medical lab to sign up for the medical lab's services.

After validation module 510 validates the medical lab, binding module 512 receives, from the healthcare provider, the lab sign up request for connecting the healthcare provider to the medical lab. For example, binding module 512 may receive, from the healthcare provider, the lab sign up request after healthcare provider server 502's user clicks on the lab sign up button displayed on healthcare provider server 502. The lab sign up request includes the account number of the lab and a healthcare provider identifier. In response to receipt of the lab sign up request, binding module 512 binds the healthcare provider and the medical lab via the EHR system. As part of the binding process, binding module 512 may want to ensure that the medical lab approves the lab sign up request from the healthcare provider. For example, after receiving the lab sign up request from the healthcare provider, binding module 512 may forward the lab sign up request to the medical lab. After the medical lab approves the lab sign up request for the healthcare provider, binding module 512 receives an approval response from the medical lab and then binds the healthcare provider and the medical lab.

Once binding module 512 finishes the binding between the healthcare provider and the medical lab, the EHR system can help the healthcare provider to place lab test orders to the medical lab through ordering module 514. Ordering module 514 may receive a lab test order for a patient of the healthcare provider. The lab test order may contain identifiers for the patient and the healthcare provider. The lab test order may also include the medical lab's account number. With the account number in the lab test order ordering module 514 can retrieve information associated with the medical lab (including the connection information) and place the lab test order to the medical lab.

After the medical lab completes the lab test and generates results ordering module 514 may receive one or more lab test results for the lab test from the medical lab. Ordering module 514 then stores the one or more lab test results in the EHR system. In some embodiments ordering module 514 may instruct notification module 516 to send notification messages indicating that the one or more results of the lab test are available in the EHR system to the patient and/or the healthcare provider. Notification module 516 may send the notification messages to patient device 506. Notification module 516 may also send the notification messages to healthcare provider server 502.

Interface module 518 outputs for display a lab sign up graphical user interface (GUI) to healthcare provider server 502. In some embodiments, interface module 518 outputs for display the lab sign up GUI after the validation module completes the validation process. The lab sign up GUI may be a web page provided by a web server of the EHR system. In another embodiment, the lab sign up GUI is a part of a standalone client application connected to the EHR system. In the lab sign up GUI, the EHR system provides an option for the healthcare provider to sign up for the medical lab's services. In one example, the EHR system displays a lab sign up button in the lab sign up GUI. The label of the lab sign up button may the medical lab's name or logo. If validation module 510 assigns an account number to the medical lab, the GUI may embed the account number of the medical lab and associate the lab sign up button with the account number. After a user of the healthcare provider clicks the lab sign up button, healthcare provider server 502 sends a lab sign up request to EHR server 508 and EHR server 508 can take care of the rest of the lab sign up process without additional work on the healthcare provider side.

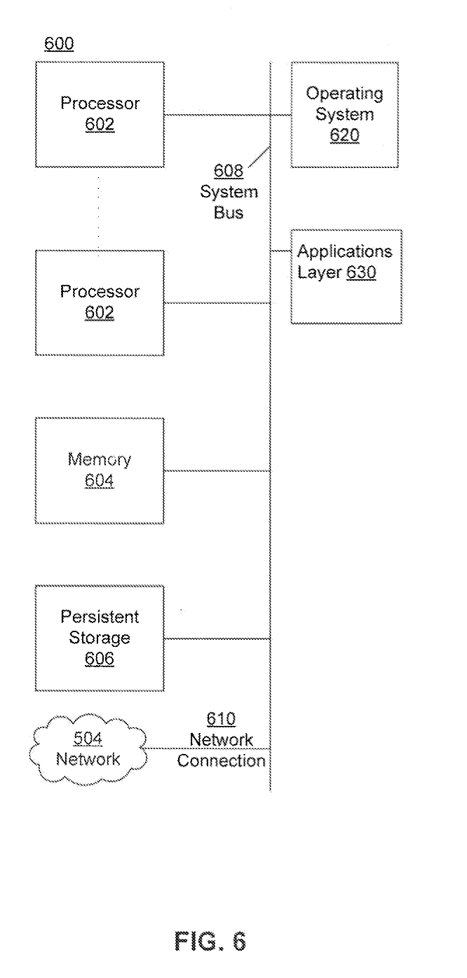

An example computing device is illustrated in FIG. 6. FIG. 6 is a diagram illustrating a computing device 600 that accesses a network 504 over a network connection 610 that provides computing device 600 with telecommunications capabilities. Computing device 600 uses an operating system 620 as software that manages hardware resources and coordinates the interface between hardware and software.

In an embodiment, computing device 600 contains a combination of hardware, software and firmware constituent parts that allow it to run an applications layer 630. Computing device 600, in embodiments, may be organized around a system bus 608, but any type of infrastructure that allows the hardware infrastructure elements of computing device 600 to communicate with and interact with each other may also be used.

Processing tasks in the embodiment of FIG. 6 are carried out by one or more processors 602. However, it should be noted that various types of processing technology may be used here, including multi-core processors, multiple processors or distributed processors. Additional specialized processing resources such as graphics, multimedia or mathematical processing capabilities may also be used to aid in certain processing tasks. These processing resources may be hardware, software or an appropriate combination thereof. For example, one or more of processors 602 may be a graphics-processing unit (GPU). In an embodiment, a GPU is a processor that is a specialized electronic circuit designed to rapidly process mathematically intensive applications on electronic devices. The GPU may have a highly parallel structure that is efficient for parallel processing of large blocks of data, such as mathematically intensive data common to computer graphics applications, images and videos.

To manipulate data in accordance with embodiments describe herein, processors 602 access a memory 604 via system bus 608. Memory 604 is nontransitory memory, such as random access memory (RAM). Memory 604 may include one or more levels of cache. Memory 604 has stored therein control logic (i.e., computer software) and/or data. For data that needs to be stored more permanently, processors 602 access persistent storage 606 via system bus 608. Persistent storage 606 may include, for example, a hard disk drive and/or a removable storage device or drive. A removable storage drive may be an optical storage device, a compact disc drive, flash memory, a floppy disk drive, a magnetic tape drive, tape backup device and/or any other storage device/drive.

Processors 602, memory 604 and persistent storage 606 cooperate with operating system 620 to provide basic functionality for computing device 600. Operating system 620 provides support functionality for applications layer 630.

Network connection 610 enables computer device 600 to communicate and interact with any combination of remote devices, remote networks, remote entities, etc. For example, network connection 610 may allow computer device 600 to communicate with remote devices over network 504, which may be a wired and/or wireless network and which may include any combination of LANs, WANs, the Internet, etc. Control logic and/or data may be transmitted to and from computer device 600 via network connection 610.

Applications layer 630 may house various modules and components. For example, validation module 510, binding module 512 ordering module 514, notification module 516 and interface module 518 may be included in applications layer 630 when computing device 600 is used as EHR server 508.

It should be noted that computer-readable medium embodiments may include any physical medium which is capable of encoding instructions that may subsequently by used by a processor to implement methods described herein. Example physical media may include floppy discs, optical discs (e.g. CDs, mini-CDs, DVDs, HD-DVD, Blu-ray), hard drives, punch cards, tape drives, flash memory or memory chips. However, any other type of tangible, persistent storage that can serve in the role of providing instructions to a processor may be used to store the instructions in these embodiments.

### Comprehensive EHR System

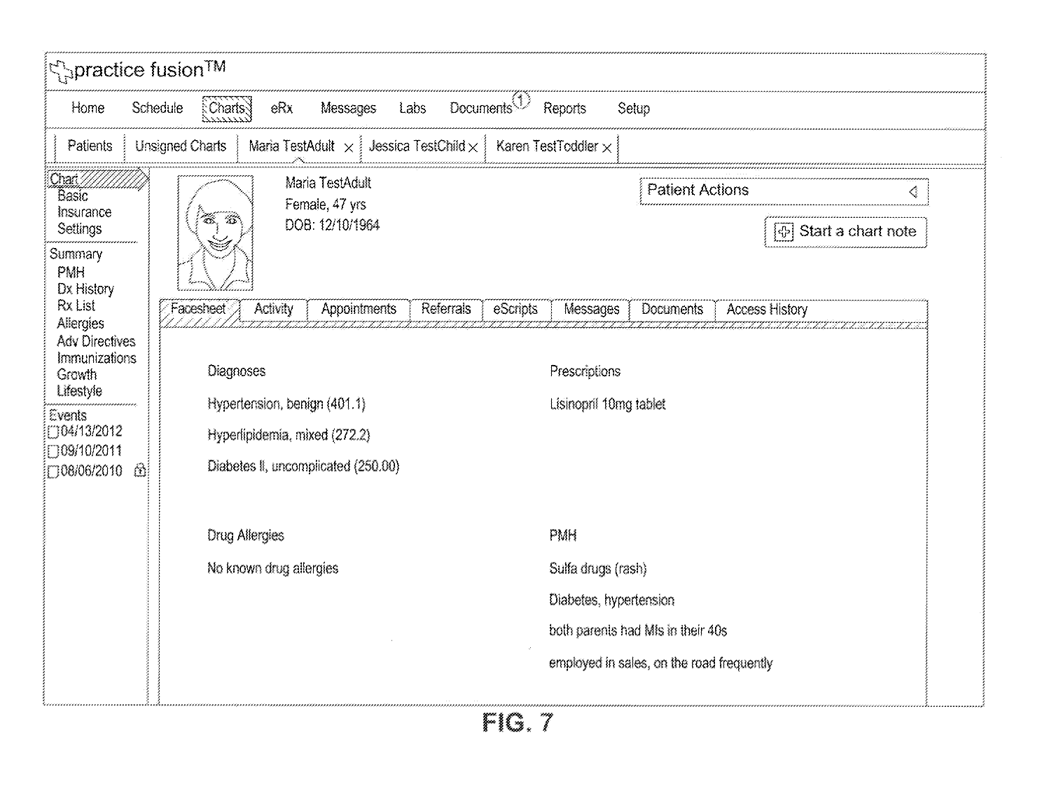

A comprehensive EHR system includes a variety of components. Components of EHR systems vary from vendor to vendor and from setting to setting. For example, an EHR system in which embodiments of the present invention can be used may also include: (1) an electronic prescription (eRx) component, (2) a clinical and radiology laboratory component, (3) a transfer of care component, (4) a scheduling component, (5) a billing service component and (6) patient portal component. FIG. 7 illustrates an example medical record.

The electronic prescription component provides medical professionals capabilities to electronically generate and transmit prescriptions for patients' medications. Some EHR systems enable prescribers to view their patients' prescription benefit information at the point of care and select medications that are on formulary and covered by the patient's drug benefit. This informs physicians of potential lower cost alternatives (such as generic drugs) and reduces administrative burden of pharmacy staff and physicians related to benefit coverage.

The clinical and radiology laboratory component allows medical professionals to integrate with clinical laboratories to electronically receive and incorporate clinical laboratory tests and results into a patient's chart and create computerized provider order entry (“CPOE”) clinical laboratory orders. This component can also support functionality that enables medical professionals to electronically receive and incorporate radiology laboratory test results (e.g., x-ray, ultrasound, MRI, PET/CT scan, mammography) into a patient's chart.

Medical professionals can use the transfer of care component to transmit referrals electronically to other EHR users or to non-users by facsimile. Additionally, some EHR systems support electronically creating and transmitting consolidated continuity of care documents.

The scheduling component offers functionality that allows healthcare providers to manage their appointments with an electronic schedule that can be integrated into a practice's workflow.

The billing service component offers medical professionals the ability to electronically generate and transmit superbills. Superbills are the data source for the creation of a healthcare claim. The billing service component can transmit superbills to medical billing software accounts controlled by the professionals' offices or their billing service providers. This component also allows a healthcare professional to save a superbill and transmit it to the healthcare professional's billing account with the billing software vendor.

The patient portal component allows medical professionals to grant their patients an online means to view, download and transmit their health information, often called the personal health record (PHR). This component also provides patients with the ability to review their physicians and send and receive secure messages directly to and from their physicians.

Together, these components leverage the benefits of EHRs while mitigating the risks.

### CONCLUSION

Identifiers, such as “(a),” “(b),” “(i),” “(ii),” etc., are sometimes used for different elements or steps. These identifiers are used for clarity and do not necessarily designate an order for the elements or steps.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

What is claimed is:

1. A computer-implemented method for integrating a healthcare provider with a medical lab, comprising:
(a) validating the medical lab in an electronic health record (EHR) system to ensure that the medical lab is able to communicate with the EHR system in a format the EHR system understands;
after the medical lab is validated:
(b) receiving, from the healthcare provider, a lab sign up request for connecting the healthcare provider to the medical lab;
(c) in response to receipt of the lab sign up request, binding the healthcare provider and the medical lab via the EHR system; and
(d) ordering a lab test for a patient of the healthcare provider to the medical lab.

2. The method of claim 1, further comprising:
(e) receiving one or more results for the lab test from the medical lab;
(f) storing the one or more results for the lab test in the EHR system; and
(g) notifying the patient or the healthcare provider that the one or more results for the lab test are available in the EHR system.

3. The method of claim 2, wherein the receiving (e) comprises:
determining that the medical lab sends the one or more results for the lab test at a first rate higher than what the EHR system can handle;
when the EHR system determines that the medical lab sends the one or more results at the first rate higher than what the EHR system can handle;
enabling throttling by notifying the medical lab to slow down and send the one or more results at a second rate that the EHR system can handle; and
accepting the one or more results at the second rate.

4. The method of claim 1, wherein the validating (a) comprises:
receiving a test message from the medical lab;
verifying formatting of the test message; and
receiving a notification from an operator of the EHR system that the medical lab is authorized.

5. The method of claim 4, wherein the test message comprises information associated with the medical lab including connection information to the medical lab,
the validating (a) comprises storing the information associated with the medical lab in the EHR system and
the ordering (d) comprises ordering the lab test by connecting to the medical lab using the stored information associated with the medical lab.

6. The method of claim 5, further comprising:
assigning an account number to the medical lab; and
displaying a lab sign up button labeled with a name of the medical lab in a graphical user interface (GUI), wherein the lab sign up button is associated with the account number embedded in the GUI.

7. The method of claim 6, wherein the receiving (b) comprises:
receiving, from the healthcare provider, the lab sign up request for connecting the healthcare provider to the medical lab responsive to a user click of the lab sign up button, the lab sign up request comprising the account number of the medical lab and a healthcare provider identifier.

8. The method of claim 1, wherein the binding (c) comprises:
forwarding the lab sign up request to the medical lab;
receiving an approval response from the medical lab; and
binding the healthcare provider and the medical lab after receiving the approval response.

9. A system for integrating a healthcare provider with a medical lab, comprising:
a computing device;
a database;
a validation module, implemented on the computing device, configured to validate the medical lab in an electronic health record (EHR) system to ensure that the medical lab is able to communicate with the EHR system in a format the EHR system understands
a binding module, implemented on the computing device, configured to:
receive, from the healthcare provider, a lab sign up request for connecting the healthcare provider to the medical lab after the medical lab is validated and
in response to receipt of the lab sign up request, bind the healthcare provider and the medical lab via the EHR system; and
an ordering module, implemented on the computing device, configured to order a lab test for a patient of the healthcare provider to the medical lab.

10. The system of claim 9, wherein the ordering module is further configured to:
receive one or more results for the lab test from the medical lab and
store the one or more results for the lab test in the EHR system; and
the system further comprises a notification module to notify the patient or the healthcare provider that the one or more results for the lab test are available in the EHR system.

11. The system of claim 10, wherein the ordering module is further configured to:
determine that the medical lab sends the one or more results for the lab test at a first rate higher than what the EHR system can handle;
when the ordering module determines that the medical lab sends the one or more results at the first rate higher than what the EHR system can handle:
enable throttling by notifying the medical lab to slow down and send the one or more results at a second rate that the EHR system can handle; and
accept the one or more results at the second rate.

12. The system of claim 9, wherein the validation module is further configured to:
receive a test message from the medical lab;
verify formatting of the test message; and
receive a notification from an operator of the EHR system that the medical lab is authorized.

13. The system of claim 12, wherein the test message comprises information associated with the medical lab including connection information to the medical lab,
the validation module is further configured to store the information associated with the medical lab in the EHR system and
the ordering module is further configured to order the lab test by connecting to the medical lab using the stored information associated with the medical lab.

14. The system of claim 13, wherein
the validation module is further configured to assign an account number to the medical lab and
the system further comprises an interface module, implemented on the computing device, configured to display a lab sign up button labeled with a name of the medical lab in a graphical user interface (GUI), wherein the lab sign up button is associated with the account number embedded in the GUI.

15. The system of claim 14, wherein the binding module is further configured to:
receive, from the healthcare provider, the lab sign up request for connecting the healthcare provider to the medical lab responsive to a user click of the lab sign up button, the lab sign up request comprising the account number of the medical lab and a healthcare provider identifier.

16. The system of claim 9, wherein the binding module is further configured to:
forward the lab sign up request to the medical lab;
receive an approval response from the medical lab; and
bind the healthcare provider and the medical lab after receiving the approval response.

17. A program storage device tangibly embodying a program of instructions executable by at least one machine for integrating a healthcare provider with a medical lab, said method comprising:
(a) validating the medical lab in an electronic health record (EHR) system to ensure that the medical lab is able to communicate with the EHR system in a format the EHR system understands;
after the medical lab is validated:
(b) receiving, from the healthcare provider, a lab sign up request for connecting the healthcare provider to the medical lab;
(c) in response to receipt of the lab sign up request, binding the healthcare provider and the medical lab via the EHR system; and
ordering a lab test for a patient of the healthcare provider to the medical lab.

18. The program storage device of claim 17, further comprising:
(e) receiving one or more results for the lab test from the medical lab;
(f) storing the one or more results for the lab test in the EHR system; and
(g) notifying the patient or the healthcare provider that the one or more results of the lab test are available in the EHR system.

19. The program storage device of claim 18, wherein the receiving (e) comprises:
determining that the medical lab sends the one or more results for the lab test at a first rate higher than what the EHR system can handle;
when the EHR system determines that the medical lab sends the one or more results at the first rate higher than what the EHR system can handle;
enabling throttling by notifying the medical lab to slow down and send the one or more results at a second rate that the EHR system can handle; and
accepting the one or more results at the second rate.

20. The program storage device of claim 17, wherein the validating (a) comprises:
receiving a test message from the medical lab;
verifying formatting of the test message; and
receiving a notification from an operator of the EHR system that the medical lab is authorized.

21. The program storage device of claim 20, wherein the test message comprises information associated with the medical lab including connection information to the medical lab,
the validating (a) comprises storing the information associated with the medical lab in the EHR system and
the ordering (d) comprises ordering the lab test by connecting to the medical lab using the stored information associated with the medical lab.

22. The program storage device of claim 21, further comprising:
assigning an account number to the medical lab; and
displaying a lab sign up button labeled with a name of the medical lab in a graphical user interface (GUI), wherein the lab sign up button is associated with the account number embedded in the GUI.

23. The program storage device of claim 22, wherein the receiving (b) comprises:
receiving, from the healthcare provider, the lab sign up request for connecting the healthcare provider to the medical lab responsive to a user click of the lab sign up button, the lab sign up request comprising the account number to the medical lab and a healthcare provider identifier.

24. The program storage device of claim 17, wherein the binding (c) comprises:
forwarding the lab sign up request to the medical lab;
receiving an approval response from the medical lab; and
binding the healthcare provider and the medical lab after receiving the approval response.
